(19) United States
(12) Patent Application Publication
(10) Pub. No.: US 2010/0296453 A1
(43) Pub. Date: Nov. 25, 2010

(54) APPARATUS AND METHOD COMPRISING AT LEAST ONE RESOURCE RECORD

(75) Inventors: Tom Patrik Grahn, Vantaa (FI); Mikko Tapani Heikkila, Tampere (FI); Miikka Martti Einari Huomo, Espoo (FI); Kari Pekka Kauranen, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: NOKIA SIEMENS NETWORKS OY, Espoo (FI)

(21) Appl. No.: 12/863,512

(22) PCT Filed: Jan. 28, 2008
(86) PCT No.: PCT/EP2008/050983

§ 371 Date: Jul. 26, 2010

(51) Int. Cl. H04W 40/00; G06F 15/16

(52) U.S. Cl. 370/328; 709/245

(57) ABSTRACT

Embodiments provide a method and apparatus configured to store at least one record which comprises information on an address of an access point and on the type of the access point. The method or apparatus may return the information on the address and on the type of the access point in response to a query request requesting the address of the access point. The apparatus may be a domain name server.

### FIELD OF TECHNOLOGY AND BACKGROUND OF THE INVENTION

The invention generally relates to communication and network elements, methods, apparatuses, systems and programs of or for communication.

An evolution of GSM, global system for mobile communications, network architecture is SAE, system architecture evolution, which has also been named by 3GPP as evolved packet service, EPS. The terms SAE or EPS may be used interchangeably. 3GPP is defining EPS in Release 8 as a framework for an evolution or migration of the 3GPP system to support systems of multiple radio-access technologies providing high data rate, low latency optimized systems.

### SUMMARY

In accordance with at least one or all of the embodiments, the invention provides an apparatus configured to store at least one record, the record comprising information on an address of an access point and on the type of the access point,

the apparatus being adapted to return the information on the address and on the type of the access point in response to a query request requesting the address of the access point.

The apparatus may be a server, or a domain name server. The apparatus may be part of, or accessible by, a network. The access point may be a gateway, a serving gateway, a packet data network gateway, or a gateway general packet radio service support node, GGSN.

The query request may be a query string for finding a gateway serving a terminal. A DNS query request may include a service-specific fully qualified domain name, FQDN.

The address of the access point name may be an internet protocol, IP, address.

The query request can be sent from a serving node or a serving entity to the apparatus. The serving node or entity can be a serving support node or a mobility management entity.

In accordance with one or more embodiments of the invention, the apparatus may be locally configured to the serving entity, a server, a domain name server, a serving support node, or a mobility management entity.

The query request may include at least one of an IP address of a sender of the query request, an access point name of the sender, information on a type of the query request, location information, and node IP address.

The query response may indicate at least one of an indication of the type of access point having the address, a protocol version supported by the access point, and an IP-address/IP-address range of the access point.

The record may comprise at least one of an indication of the type of access point, a protocol version supported by the access point, and an IP-address/IP-address range, enabling the apparatus to select an access point depending on a distance to the requesting entity, and to include the address of the selected entity or entities into the response. The record may be a resource record.

The request may e.g. relate to a context activation request such as a packet data protocol context activation request. The DNS request may e.g. be done during a PDP context activation procedure. Also in LTE (Long Term Evolution) so called default bearer may be created during E-UTRAN Initial Attach procedure, which requires UE to initiate PDP context activation request.

In accordance with one or more embodiments of the invention, the request may relate to an inter support node or inter mobility management entity handover with query of the apparatus.

In accordance with one or more of the embodiments of the invention, the record may be a service interface record usable by a client in at least one application. The service interface resource record may include information for the application to decide what protocol or what type of network element is to be used for interaction.

The record may include one or more of a variable indicating a type of service interface provider, a version of a service interface, a target of the service interface, or the record may include at least one or more of parameters, owner, time to live, class, priority, location, provider type, target name.

A query or query response may contain additional information comprising at least one of capability of a peer network element, version of the interface, location, protocol version of peer node.

The resource record may be a record for specifying the location of services, e.g. a record according to request for comments, RFC 2782.

In accordance with at least one or more of the embodiments of the invention the address may be an access point name having an extension indicating the type of the access point.

A network may comprise such an apparatus as mentioned above or in the following text. The network may comprise an evolved packet service, EPS architecture, or may comprise at least one of a serving general packet radio service support node, SGSN, a mobility management entity, MME, or a gateway are provided.

In accordance with at least one or more of the embodiments of the invention, a method may comprise receiving a query request requesting an address of an access point, checking at least one record, the record comprising information on the address of the access point and on the type of the access point, and returning the information on the address and on the type of the access point in response to the query request. The method may e.g. be executed on a server, a domain name server, or a network.

The query request can be a query string for finding a gateway serving a terminal.

In accordance with one or more of the embodiments of the invention, a computer program product is provided which comprise code means configured to carry out or implement, when run on a processor,

receiving a query request requesting an address of an access point,
checking at least one record, the record comprising information on the address of the access point and on the type of the access point, and
returning the information on the address and on the type of the access point in response to the query request.

The computer program product may e.g. be embodied on a computer-readable medium.

In accordance with one or more embodiments of the invention, a record may comprise information on an address of an access point and on the type of the access point.

In accordance with one, more or all of the embodiments of the invention, at least one of a method, system, apparatus and computer program product are provided for resource records.

In accordance with at least one or more of the embodiments of the invention, an apparatus is configured: to send a query request requesting an address of an access point,

and to receive an information on the address and on a type of the access point in response to the query request.

Optionally the apparatus may send a message to the access point depending on the received address and type information.

An apparatus may comprise at least one of means for sending a query request requesting an address of an access point, means for receiving an information on the address and on a type of the access point in response to the query request, and

means for sending a message to the access point depending on the received address and type information.

The query request may include at least one of an address or IP address of the apparatus, an access point name of the apparatus, information on a type of the query request, location information of the apparatus, a node IP address, a protocol version supported by the apparatus, and an IP-address/IP-address range of a node serving the apparatus.

The apparatus may be a support node or a mobility management entity.

In accordance with at least one or more of the embodiments of the invention, a method may comprise

sending a query request requesting an address of an access point,
receiving an information on the address and on a type of the access point in response to the query request, and
sending a message to the access point depending on the received address and type information.

The query request may include at least one of an address or IP address of the apparatus, an access point name of the apparatus, information on a type of the query request, location information of the apparatus, a node IP address, a protocol version supported by the apparatus, and an IP-address/IP-address range of a node serving the apparatus.

The method may be implemented in a support node or mobility management entity.

In accordance with one or more embodiments of the invention, a method may comprise

attaching a user to a network, which network may optionally be an evolved packet service,
connecting a mobility management entity to a serving gateway, or, if no serving gateway is reachable, redirecting the user to general packet radio service.

In accordance with one or more embodiments of the invention, a method may comprise

performing a handover, such as an Inter SGSN/MME handover, during handover a new support node or mobility management entity performs a server query to find an old support node or mobility management entity,
the new support node or mobility management entity receives from the server query information on a type or version of a peer node,
the new support node or mobility management entity uses the received information so as to speed up the handover procedure.

Embodiments of the invention may comprise one or more or all of the above or below described features in any arbitrary combination.

A computer program product may comprise code means configured to carry out or implement, when run on a processor,

sending a query request requesting an address of an access point,
receiving an information on the address and on a type of the access point in response to the query request, and
sending a message to the access point depending on the received address and type information.

Some embodiments more particular relate to resource record e.g. for domain name server, DNS, in EPS.

Other objects, features and advantages of the invention will become apparent from the following description of embodiments of the invention.

### BRIEF DESCRIPTION OF DRAWINGS

FIG. 1 illustrates an embodiment of a system and apparatuses in accordance with the invention;

FIG. 2 shows an embodiment configured in accordance with an implementation of the invention;

FIG. 3 illustrates another embodiment of the invention; and

FIG. 4 shows a further embodiment of the invention.

### DESCRIPTION OF EMBODIMENTS

In accordance with one, more or all of the embodiments, the invention relates to optimized or improved interworking between GPRS and EPS networks (also known as LTE/SAE).

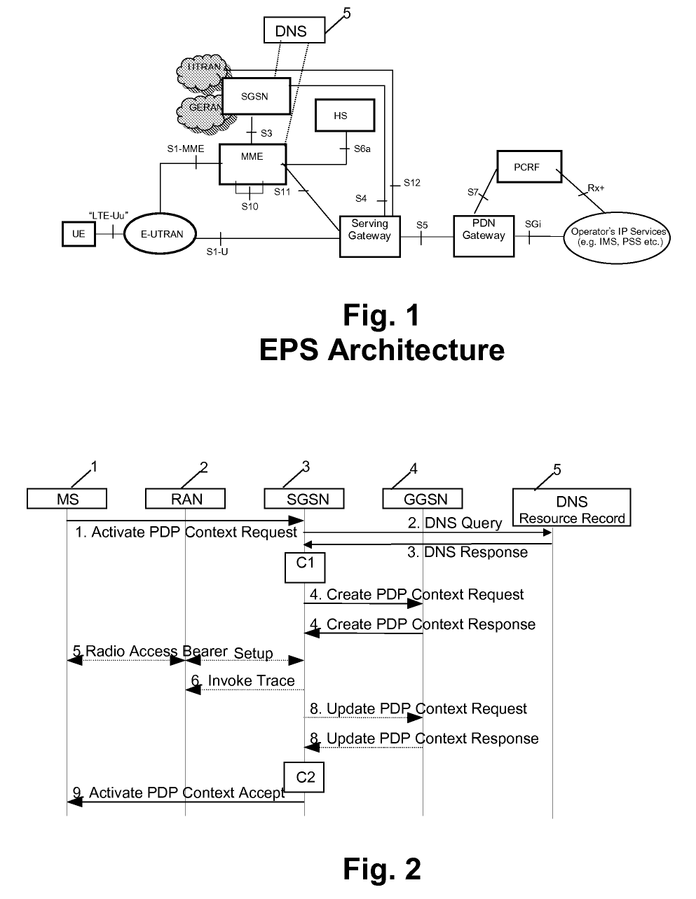

FIG. 1 illustrates an embodiment of a system and apparatuses in accordance with the invention. FIG. 1 shows an implementation in accordance with one, more or all of the embodiments of the invention which involves an EPS architecture and additionally comprises at least one server such as a domain name server, DNS, 5.

The EPS architecture shown in FIG. 1 comprises, a serving GPRS, general packet radio service, support node, SGSN, a mobility management entity, MME, for managing mobility, UE identities and security parameters, a UMTS terrestrial radio access network, UTRAN, a GERAN, GSM/EDGE, Enhanced Data rate for GSM Evolution, radio access network, E-UTRAN, a HS, a serving gateway e.g. for terminating an interface towards E-UTRAN, a PDN gateway being a node that terminates an SGi interface towards a packet data network, PDN, a PCRF, and operator's IP services (e.g. IMS, PSS etc.).

A PDN gateway (P-GW or PGW) may basically, according to an embodiment, be a gateway general packet radio service, GPRS, support node, GGSN.

According to EPS standards, a Release 8, rel8, SGSN or MME connects to a serving gateway, S-GW. Release 8 may also be abbreviated as R8 instead rel8. A Legacy SGSN (legacy=pre-rel8, releases prior to release 8) connects to a GGSN.

A domain name server, DNS, query string may be used to allow the SGSN or MME to find the S-GW, PDN-GW or GGSN. A release 8, R8, SGSN or an MME should connect to a serving gateway, S-GW or SGW, or a packet gateway, PGW. The R8 SGSN has the capability to connect to a GGSN as well. A Legacy SGSN connects to GGSN as mentioned above.

A domain name server (DNS) function may be used to resolve a DNS string into a list of possible S-GW/P-GW addresses which serve the UE location as in pre-rel8 architecture.

MME/SGSN just selects one address from the list. The procedure may be similar to procedures used in pre-rel8.

The DNS query can be done with an EPS specific fully qualified domain name, FQDN.

For both network elements such as the support node, SGSN, or the mobility management entity, MME, it is of advantage to know what type of network element, NE, the peer element such as the gateway e.g. GGSN or SGW, is.

Even if an EPS specific DNS query string is used it still is not certain whether the peer NE is a GGSN or SGW. If an SGSN connects to a GGSN it means that it must fallback to release 7, R7, level functionality, and for the MME that the user connection attempt must be rejected.

Embodiments of the invention solve this ambiguity in a DNS query.

In accordance with one, more or all of the embodiments of the invention, it is possible to indicate additional information in the query response. This additional information makes it possible for the apparatus such as MME or SGSN to know exactly the type of network entity, NE, for which the IP-address has been received. It is also possible even if A or AAAA records are used.

Many alternatives may also be used or implemented in accordance with one or more embodiments of the invention. The network may send DNS query by extending label/FQDN string with some with well known acronyms such as EPS, SGW, PGW or PMIP that clearly state what address the network is searching for.

As a further alternative embodiment, a label “eps-apn-xgw”, may be used which means that MME needs both addresses. DNS is configured to understand this label, and if DNS is capable of sending one, combined response with two addresses (or address sets), then it does so. The point is that the response must be clear tags which addresses belong to SGW and which to PGW. If the response does not have such clear tags, then MME shall understand that DNS is returning only PGW address. So, MME shall send another query with “eps-apn-sgw”.

MME sends query with a label “eps-apn-pgw”, or “eps-apn-sgw” which are straightforward cases of these embodiments.

In accordance with at least one, more or all of the embodiments of the invention, an optimized interworking between GPRS and EPS networks is provided.

In accordance with one, more or all of the embodiments of the invention, an apparatus, e.g. a serving node or entity such as SGSN or MME, retrieves an address of a gateway entity, e.g. GGSN, or S-GW, or P-GW, by performing a DNS query.

In some implementations in accordance with one or more embodiments of the invention, the information may also be locally configured to the apparatus such as SGSN or MME, or the apparatus such as SGSN or MME may retrieve the same configuration or information from any other server.

In accordance with one, more or all of the embodiments of the invention, a DNS/core network interworking is provided.

In addition to a legacy Query, which may include an IP address of a sender and an access point name, APN), the query, in accordance with one, more or all of the embodiments, includes at least one of the following additional information or parameter:
Type of Query (e.g. legacy or new)
Location information (=area code defined by the operator for the specific part of network) or node IP address.

The response from the server, e.g. DNS, has an indication of what type of element the IP-address is for (e.g. GGSN, SGW, PGW, SGSN, and MME). In addition, or alternatively, the protocol version supported by the peer node can be included into the response.

It is also possible to give an IP-address/IP-address range (e.g. of an eNB, or Evolved UTRAN eNodeB) so that the DNS is capable of responding with the geographically nearest SGW to the eNB.

Embodiments of the invention provide the possibility of indicating additional info such as type information on the network element, in the query response. This makes it possible e.g. for the MME to know exactly not only the IP-address but also the type of the network element, NE.

To allow the above changes a new resource record in the DNS 5 is defined in accordance with one, more or all of the embodiments of the invention.

FIG. 2 shows an embodiment in accordance with the invention.

In the embodiment of FIG. 2, a PDP context activation procedure e.g. for Iu mode is shown as an example.

A use case #1 of an SGSN or GGSN DNS query is shown. FIG. 2 shows a terminal 1 such as a mobile station MS like a user equipment; a radio access network, RAN, 2 which may also be a base station or radio network controller etc; a serving element such as support node SGSN 3 or a MME; a gateway element 4 such as a gateway node GGSN or a serving gateway, and a server such as a DNS 5. The server 5 comprises, or has access to a resource record, RR.

As an example UE 1 is attaching to a serving node implemented as an SGSN 3 according to release 8, Rel8 SGSN, and establishing user plane connection. Primarily SGSN 3 tries to contact to a serving gateway, e.g. SGW:

In a step 1, the user equipment MS 1 sends an Activate PDP Context Request message (including e.g. one or more of NSAPI, TI, PDP Type, PDP Address, Access Point Name, QoS Requested, Protocol Configuration Options) message to the SGSN 3. The SGSN 3 receiving this Activate PDP context request from the user equipment MS 1, queries DNS 5 for APN resolving, by sending a message 2. to the DNS 5. The DNS 5 checks its resource record so as to find not only the access point name such as an IP address but also the information on the type of network element having this IP address, and returns a response 3, which includes the IP address of a network element such as a gateway, and an indication of the type of network element, in this example the gateway. As an example, the query response 3 returned from the DNS 5 includes the address and the information that the address belongs to a GGSN 4.

This additional type information enables the SGSN 3 to send a request of a proper type, e.g. a GTPv1 (GPRS tunnel protocol version 1) Create PDP context request, to the GGSN 4 instead of trying first with a wrong version, e.g. GTPv2 message, and then retrying with GTPv1 after detecting lack of success such as receiving of an error indication.

By following this procedure there is no problem of using wrong version, signalling and messaging is reduced, and setup is also faster.

The other steps and signalling of FIG. 2 may be in accordance e.g. as specified in 3GPP TS 23.060, e.g. V7.6.0.

The SGSN 3 sends a message 4, i.e. a Create PDP Context Request message to the GGSN 4.

The GGSN creates a new entry in its PDP context table and returns a Create PDP Context response message.

E.g. in Iu mode, a RAB setup may be done by the RAB Assignment procedure, see step 5. The SGSN 3 may send an Invoke Trace message to the RAN 2. Another alternative e.g. is triggering of trace activation by other elements.

In some cases, the SGSN 3 may inform the GGSN 5, as shown in message exchange 8, about changed attributes by sending an Update PDP Context Request to the GGSN 4. The GGSN 4 confirms by sending an Update PDP Context Response to the SGSN 3. The SGSN 3 returns an Activate PDP Context Accept message to the MS 1.

CAMEL procedure calls C1, C2 may be performed as shown in FIG. 2. C1) indicates CAMEL GPRS PDP Context Establishment. C2) indicates CAMEL GPRS PDP Context Establishment Acknowledgement. In FIG. 2, the procedures C1, C2 return as result “Continue”. CAMEL stands for customised applications for mobile network enhanced logic.

In accordance with another embodiment of the invention, a use case #2 is described which relates to an Inter SGSN/MME handover with DNS query.

During handover the new SGSN or MME performs a DNS query to find the old SGSN or MME. The DNS 5 returns the type or version of the peer node so that the new SGSN can directly use the correct version speeding up the procedure.

In accordance with a further embodiment of the invention, a use case #3 is described which relates to a user attaching to EPS. In this case, the MME connects to SGW only. If no serving gateway SGW is reachable the user can be redirected to GPRS. Also MME needs not to connect to GGSNs.

The described embodiments or above mentioned features allow the DNS functionality to be more flexible, e.g. when a core network, CN, is in a transition from GPRS to EPS. A transition may last several years. By upgrading the DNS so as to include the above additional information or resource records, the operator can more flexible upgrade the rest of the CN.

Below is described an example of an implementation in accordance with one or more embodiments of the invention.

In general, a new Service Interface (SIF) record may be used by client in applications where different types of interface provider or interface type affect an application operating model.

A service interface resource record, SIF RR, is to provide enough information for the application so as to be able to decide what protocol (e.g. GTPv0/GTPv1/GTPv2) or what NE type (e.g. GGSN, SGW or PGW) should be used for interaction. As well the SIF RR optionally provides best possible service (e.g. the network element NE is chosen by geographical closeness). Such resource records may be stored e.g. in the DNS 5.

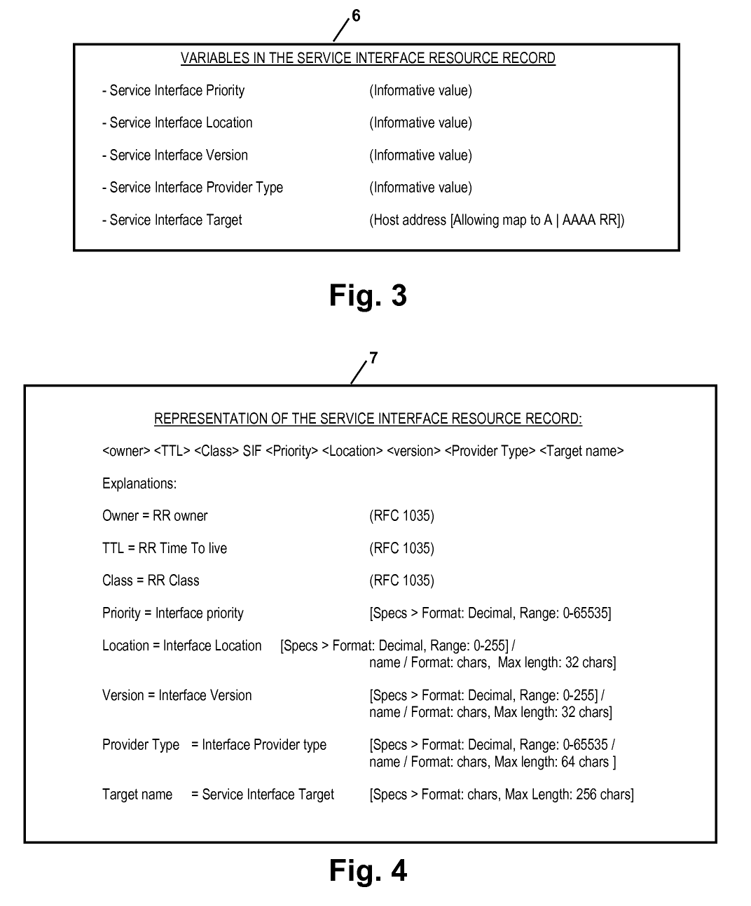

FIG. 3 shows an example of variables in a service interface resource record 6 which may be stored in or accessible to e.g. a server such as the DNS 5.

The variables may include a type of service interface provider. This variable can be or have an informative value.

Additionally or alternatively, the variables may include a version of a service interface. This variable can be or have an informative value.

Additionally or alternatively, the variables may include a target of the service interface such as a host address which may allowing mapping to A|AAAA RR.

FIG. 4 shows an embodiment of a resource record 7 of or for the service interface, as e.g. stored in DNS 5.

A textual representation of this embodiment of a SIF resource record 7 is e.g. as follows:

<owner> <TTL> <Class> SIF <Priority> <Location> <version> <Provider Type> <Target name>

### Explanations:

Owner=RR owner, e.g. as defined in RFC 1035;
TTL=RR Time To live, e.g. as defined in RFC 1035;
Class=RR Class, e.g. as defined in RFC 1035;
Priority=Interface priority, e.g. specified by Specs>Format: Decimal, Range: 0-65535;
Location=Interface Location, e.g. specified by Specs>Format: Decimal, Range: 0-255]/name/Format: chars, Max length: 32 chars];
Version=Interface Version, e.g. specified by Specs>Format: Decimal, Range: 0-255]/name/Format: chars, Max length: 32 chars];
Provider Type=Interface Provider type, e.g. specified by Specs>Format: Decimal, Range: 0-65535/name/Format: chars, Max length: 64 chars;
Target name=Service Interface Target, e.g. specified by Specs>Format: chars, Max Length: 256 chars.

The resource record may include one or more or all of the above entries in any arbitrary combination.

In the following, examples of the DNS configuration and resource records in accordance with one, more or all of the embodiments of the invention are described.

Examples of the DNS configuration include one or more of the following.

A list example #1 of a resource record includes

[1] Service name: wap.mnc001.mcc002.gprs.
[1] Address: 10.0.0.1 (ggsn1-eth1), Type: 1 (GGSN), Priority: 0, Location: 1 (Helsinki)
[2] Address: 10.0.0.2 (ggsn2-eth2), Type: 1 (GGSN), Priority: 1, Location: 2 (Tampere)
[3] Address: FECO::1 (ggsn2-eth2), Type: 1 (GGSN), Priority: 1, Location: 2 (Tampere)
[4] Address: 10.0.0.222 (pgw-eth1), Type: 2 (PGW), Priority: 0, Location: 1 (Helsinki)
[5] Address: 10.200.0.1 (sgw-eth1), Type: 3 (SGW), Priority: 0, Location: 1 (Helsinki)

A list example #2 of a resource record includes

[1] Service name: _gprs._env.mnc001.mcc002.gprs.

### [1] Location: 1 (Helsinki)

[1] Address: 10.0.0.1 (ggsn1-eth1), Type: 1 (GGSN), Priority: 0
[2] Address: 10.0.0.222 (pgw-eth1), Type: 2 (PGW), Priority: 0
[3] Address: 10.200.0.1 (sgw-eth1), Type: 3 (SGW), Priority: 0
[4] Address: FED0::1 (sgw-eth1), Type: 3 (SGW), Priority: 0
[5] Address: 10.0.0.100 (rnc1), Type: 100 (RNC), Priority: 0

### [2] Location: 2 (Tampere)

[1] Address: 10.7.100.1 (ggsn10-eth1), Type: 1 (GGSN), Priority: 0
[2] Address: 10.0.0.2 (ggsn2-eth2), Type: 1 (GGSN), Priority: 1
[3] Address: FECO::1 (ggsn2-eth2), Type: 1 (GGSN), Priority: 1
[4] Address: 10.7.100.2 (sgw20-eth1), Type: 1 (GGSN), Priority: 1
[5] Address: FECO:1::1 (sgw20-eth1), Type: 1 (GGSN), Priority: 1
[6] Address: 10.7.100.100 (rnc20), Type: 100 (RNC), Priority: 0

Embodiments of the invention such as the described embodiments provide one or more or all of the following or further advantages. DNS queries are optimized or quicker and load-reducing as one query can contain all the necessary information, additional queries are not needed. A query or query response contains additional information such as capabilities of the peer network elements, versions of the interface, location to minimize the distance in user plane transport path etc. An information of the protocol version of peer node as sent to the inquiring apparatus such as SGSN or MME is e.g. useful when DNS query is performed to locate the IP address of an SGSN.

The apparatus such as DNS and MME are implemented so as to support this type of query.

In accordance with other embodiments of the invention, another alternative is to follow a format of the SRV RR (Refer to RFC 2782) by adding the new information to ADDITIONAL SECTION. A DNS RR of RFC 2782 may specify the location of server(s) for a specific protocol and domain.

An SRV RR allows administrators to use several servers for a single domain, to move services from host to host with little fuss, and to designate some hosts as primary servers for a service and others as backups.

The usage of SRV is standardized in RFC 2782 and this functionality can be implemented to both client and server side.

In accordance with another embodiment of the invention, a further alternative solution to minimize the effort is to use a new access point name APN for EPS purposes. DNS may identify the new APN and is, in accordance with this embodiment, able to convert the EPS FQDN to a GPRS one. According to this embodiment, the DNS is able to change an attribute or part such as the extension .eps to .gprs in the FQDN string. This allows the operator to have legacy SGSN's in the network without any changes as the DNS could return GPRS APN in case EPS is not found. This alternative may require proprietary implementation as all DNS may not support EPS as well as client side may have restrictions. Also in this alternative it is not certain which element address is returned in the response (MME may e.g. receive GGSN address).

For the purpose of the present invention as described herein above, it should be noted that any access or network technology may be used which may be any technology by means of which a user equipment can access a network. The network may be any device, unit or means by which a mobile or stationary entity or other user equipment may connect to and/or utilize services offered by the network. Such services may include, among others, data and/or (audio-) visual communication, data download etc.

Generally, the present invention is also applicable in those network/terminal environments relying on a data packet based transmission scheme according to which data are transmitted in data packets and which are for example based on the Internet Protocol IP. The present invention is, however, not limited thereto, and any other present or future IP or mobile IP version, or, more generally, a protocol following similar principles is also applicable. The user equipment entity may be any device, unit or means by which a system user may experience services from a network.

The sequence of method steps described above or shown in the drawings can be implemented in any other sequence arbitrarily deviating from the above described or shown sequence of steps. The method steps may be implemented as software code portions and be run using a processor at a network element or terminal, can be software code independent, or can be specified using any known or future developed programming language as long as the functionality defined by the method steps is preserved. Generally, any method step is suitable to be implemented as software or by hardware without changing the idea of the present invention in terms of the functionality implemented. Method steps and/or devices, units or means may be implemented as hardware components at a mobile station or network element or module thereof, may be hardware independent, and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. Devices, units or means (e.g. User equipment, CSCF) can be implemented as individual devices, units or means, but may also be implemented in a distributed fashion throughout a system, as long as the functionality of the device, unit or means is preserved.

### LIST OF ABBREVIATIONS

CN Core Network
EPS Evolved Packet System
FQDN Fully Qualified Domain Name
NE Network Element
PGW PDN GateWay
RFC Request For Comments
SGW Serving GateWay
RR Resource Record
NE Network Element

1-43. (canceled)

44. An apparatus configured to store at least one record, the record comprising information on an address of an access point and on the type of the access point,
the apparatus being adapted to return the information on the address and on the type of the access point in response to a query request requesting the address of the access point.

45. Apparatus according to claim 44, wherein the apparatus is a server, or a domain name server.

46. Apparatus according to claim 44, wherein the apparatus is part of, or accessible by, a network.

47. Apparatus according to claim 44, wherein the access point is a gateway, a serving gateway, a packet data network gateway, or a gateway general packet radio service support node, GGSN.

48. Apparatus according to claim 44, wherein the query request is a query string for finding a gateway serving a terminal.

49. Apparatus according to claim 44, wherein the DNS query request includes a service-specific fully qualified domain name, FQDN.

50. Apparatus according to claim 44, wherein the address of the access point name is an internet protocol, IP, address.

51. Apparatus according to claim 44, wherein the query request is received from a serving node or a serving entity.

52. Apparatus according to claim 51, wherein the serving node or entity is a serving support node or a mobility management entity.

53. Apparatus according to claim 44, wherein the apparatus is locally configured to the serving entity, a server, a domain name server, a support node, a serving support node, or a mobility management entity.

54. Apparatus according to claim 44, wherein the query request includes at least one of an IP address of a sender of the query request, an access point name of the sender, information on a type of the query request, location information, and node IP address.

55. Apparatus according to claim 44, wherein the query response indicates at least one of an indication of the type of access point having the address, a protocol version supported by the access point, and an IP-address/IP-address range of the access point.

56. Apparatus according to claim 44, wherein the record comprises at least one of an indication of the type of access point, a protocol version supported by the access point, and an IP-address/IP-address range, enabling the apparatus to select an access point depending on a distance to the requesting entity, and to include the address of the selected entity into the response.

57. Apparatus according to claim 44, wherein the record is a resource record.

58. Apparatus according to claim 44, wherein the request relates to a context activation procedure.

59. Apparatus according to claim 44, wherein the request relates to a packet data protocol context activation procedure.

60. Apparatus according to claim 44, wherein the request relates to an inter support node or inter mobility management entity handover with query of the apparatus.

61. Apparatus according to claim 44, wherein the record is a service interface record usable by a client in at least one application.

62. Apparatus according to claim 61, wherein the service interface resource record includes information for the application to decide what protocol or what type of network element is to be used for interaction.

63. Apparatus according to claim 44, wherein the record includes one or more of a variable indicating a type of service interface provider, a version of a service interface, a target of the service interface, or, the record includes at least one or more of parameters, owner, time to live, class, priority, location, provider type, target name.

64. Apparatus according to claim 44, wherein a query or query response contains additional information comprising at least one of capability of a peer network element, version of the interface, location, protocol version of peer node.

65. Apparatus according to claim 44, wherein the resource record is a record for specifying the location of services.

66. Apparatus according to claim 44, wherein the resource record is a record according to request for comments, RFC 2782.

67. Apparatus according to claim 44, wherein the address is an access point name having an extension indicating the type of the access point.

68. An apparatus being configured to at least one of:
to send a query request requesting an address of an access point,
to receive an information on the address and on a type of the access point in response to the query request, and
to send a message to the access point depending on the received address and type information.

69. Apparatus comprising at least one of means for sending a query request requesting an address of an access point,
means for receiving an information on the address and on a type of the access point in response to the query request, and
means for sending a message to the access point depending on the received address and type information.

70. Apparatus according to claim 68, wherein the query request includes at least one of an address or IP address of the apparatus, an access point name of the apparatus, information on a type of the query request, location information of the apparatus, a node IP address, a protocol version supported by the apparatus, and an IP-address/IP-address range of a node serving the apparatus.

71. Apparatus according to claim 68, wherein the apparatus is a support node or a mobility management entity.

72. Network, comprising an apparatus according to claim 68.

73. Network according to claim 72, wherein the network comprises an evolved packet service, EPS architecture, or a Release 8 architecture according to 3GPP.

74. Network according to claim 72, comprising at least one of a serving general packet radio service support node, SGSN, a mobility management entity, MME, or a gateway are provided.

75. A method, comprising:
receiving a query request requesting an address of an access point,
checking at least one record, the record comprising information on the address of the access point and on the type of the access point, and
returning the information on the address and on the type of the access point in response to the query request.

76. Method according to claim 75, wherein the method is executed on a server, a domain name server, a support node, a serving support node, a mobility management entity, or a network.

77. Method according to claim 75, wherein the query request is a query string for finding a gateway serving a terminal.

78. A method, comprising:
sending a query request requesting an address of an access point,
receiving an information on the address and on a type of the access point in response to the query request, and
sending a message to the access point depending on the received address and type information.

79. Method according to claim 78, wherein the query request includes at least one of an address or IP address of the apparatus, an access point name of the apparatus, information on a type of the query request, location information of the apparatus, a node IP address, a protocol version supported by the apparatus, and an IP-address/IP-address range of a node serving the apparatus.

80. Method according to claim 78, wherein the method is implemented in a support node or mobility management entity.

81. A method, comprising:
attaching a user to a network, optionally an evolved packet service,
connecting a mobility management entity to a serving gateway, or, if no serving gateway is reachable, redirecting the user to general packet radio service.

82. A method, comprising:
performing a handover, such as an Inter SGSN/MME handover,
during handover a new support node or mobility management entity performs a server query to find an old support node or mobility management entity,
the new support node or mobility management entity receives from the server query information on a type or version of a peer node,
the new support node or mobility management entity uses the received information so as to speed up the handover procedure.

83. Computer program product, comprising code means configured to carry out or implement, when run on a processor,
receiving a query request requesting an address of an access point,
checking at least one record, the record comprising information on the address of the access point and on the type of the access point, and
returning the information on the address and on the type of the access point in response to the query request.

84. Computer program product, comprising code means configured to carry out or implement, when run on a processor,
sending a query request requesting an address of an access point,
receiving an information on the address and on a type of the access point in response to the query request, and
sending a message to the access point depending on the received address and type information.

85. Computer program product according to claim 83, embodied on a computer-readable medium.

86. A record, the record comprising information on an address of an access point and on the type of the access point.
